(19) United States
(12) Patent Application Publication
(10) Pub. No.: US 2016/0094260 A1
(43) Pub. Date: Mar. 31, 2016

(54) Adapter to Attach Computer to Wrist Band

(71) Applicant: Steven N. Verona, Miami Beach, FL (US)

(72) Inventor: Steven N. Verona, Miami Beach, FL (US)

(21) Appl. No.: 14/867,567

(22) Filed: Sep. 28, 2015

Related U.S. Application Data
(60) Provisional application No. 62/055,767, filed on Sep. 26, 2014.

(51) Int. Cl. H04B 1/3827; H04B 1/3888

(52) U.S. Cl. CPC H04B 1/385; H04B 1/3888

(57) ABSTRACT

An apparatus for mounting a computer, such as a smart watch, to a wrist-encircling band, such as a bracelet or watch band. This provides the wearer with the advantage of an attractive watch or bracelet, along with the functionality of a smart watch or other computer and the ability to avoid wearing two articles encircling the wrist. The apparatus includes a panel that the smart watch may mount to, and an arm extending from the panel to attach to the band. The panel and arm may be a single, integrated structure, or they may be removably mounted together. A strip may encircle the panel and arm, along with the band, in order to provide a removable fastener to the band. The smart watch may mount to the panel using conventional fasteners or using the mounting structures inherent in the watch, such as watch band mounting structures.

### CROSS-REFERENCES TO RELATED APPLICATIONS

This application claims the benefit of U.S. Provisional Application No. 62/055,767 filed Sep. 26, 2014. This prior application is hereby incorporated by reference.

### STATEMENT REGARDING FEDERALLY-SPONSORED RESEARCH AND DEVELOPMENT

(Not Applicable)

### THE NAMES OF THE PARTIES TO A JOINT RESEARCH AGREEMENT

(Not Applicable)

### REFERENCE TO AN APPENDIX

(Not Applicable)

### BACKGROUND OF THE INVENTION

The invention relates generally to wristwatches and wrist jewelry, and more particularly to an apparatus for mounting an electronic computer to a wrist-encircling structure.

Conventional wristwatches have a flexible band that extends around a person's wrist to fasten with a clasp, and a watch body to which the band attaches. The watch body houses the mechanical components of an analog watch or the electronic components of a digital watch. The watch body has a visible face that is typically positioned on the back of the wrist (facing away from the palm) in order for the wearer to view readily by simply twisting the forearm in such a way as to allow him or her to see the time and other information, such as date, day of the week, etc. displayed on the face.

Newer electronic wrist accessories include so-called “smart watches”, which are typically a small touchscreen computer that makes a wireless connection to a smart phone (e.g., Android, IOS or any other operating system). Smart watches allow the wearer to view information, or feel an alert via vibration, on the smart watch that would otherwise be presented on the smart phone, thereby allowing the wearer to avoid viewing the phone's screen while still interacting with the smartphone to accomplish certain tasks. Thus, smart watches present some information to the wearer that the smart phone would otherwise present, but the wearer can view the information merely by looking at the face of the smart watch as conveniently as one would look at the already-exposed face of a conventional wrist watch. This relieves the wearer of the task of retrieving the smart phone from its receptacle, such as a pocket, purse or holster, to view its screen and perform tasks such as replying to a text message.

One disadvantage of smart watches is that they are not as varied in their appearance as conventional watches. While smart watches provide advantageous functions, they are considered plain and non-decorative. Some wearers of wrist watches consider watches to be a fashion accessory in the manner of a bracelet or other jewelry, and the appearance of the watch is important to the wearer. However, conventional wrist watches lack smart watch capabilities.

The need exists for a means for gaining smart watch capabilities while retaining the decorative features, and wide variations in appearance, of conventional watches.

### BRIEF SUMMARY OF THE INVENTION

The invention allows the wearer of a conventional wrist watch to add smart watch capabilities to a conventional wrist watch by an apparatus that permits attachment of a smart phone, smart watch or any component having similar computer capabilities, to the conventional wrist watch or other wrist-encircling structures, such as bracelets. This is accomplished by a structure with a panel to which the electronic components' housing mounts, and an arm that extends rigidly or semi-rigidly from the panel and attaches to the watch band or body of the conventional wrist watch. The structure may be used with any limb-encircling structure, and the limb may be an arm or a leg.

The mounting panel is the portion of the structure to which the electronic component is mounted, such as by a fastener, including without limitation adhesive, clamps, magnets, a friction-fitted group of perimeter fingers that the electronic device is pressed into, or any other attaching mechanism. In one embodiment, the electronic component is an APPLE brand smart watch with the band thereof removed to expose slots on opposing sides of the housing into which correspondingly-shaped bars are inserted for fastening. Alternatively, the electronic component may be a smartphone, personal digital assistant, IPOD brand computer, or any similar device.

The mounting panel may be a substantially planar structure that is relatively thin (e.g., 1 mm to 1 cm thick) and is preferably created, such as from injection-molded plastic, metal or another strong material, to similar exterior dimensions as the electronic device that will be attached to the panel. Alternatively, the panel may be formed by a frame of tubular or other members that extend around the perimeter of the housing for the electronic component. The housing for the electronics may be inserted between the members. The panel may have fingers at each corner, at each side or at two opposing sides of the panel. The electronic device may be mounted by first pressing it between the two or more fingers, thereby expanding the fingers outwardly away from the device, and creating a bias against the sides of the device's case. The biased fingers may maintain a friction grip on the device to maintain its position relative to the panel. Of course, the panel may use another fastening means, including adhesive, VELCRO brand hooks and loops, magnets or similar. Such fastening means may attach to the panel in many other ways that will become apparent to the person of ordinary skill from this description.

The arm is mounted to the panel and may extend from the panel toward the watch's band or body. The watch band may be leather, plastic, metal or any other material. The arm of the structure may be within the same plane as the panel or the arm may extend into one or more different planes to accommodate the thickness of the watch band or some other structure. The arm may be a panel or strip, but may alternatively be one or more elongated rods as described in more detail below. The arm may be formed by a frame of tubular or other members that extend away from the panel.

The band may have a special attachment feature to permit the arm to attach to the band. For example, the watch band may be made with one or more channels, grooves or other voids that permit the insertion of the arm into the void or voids. This is particularly useful if the arm is formed by one or more elongated rods that can extend into one or more corresponding bores formed in the watch band. The band may alternatively or additionally have protrusions, such as elongated rods, extending therefrom that insert into one or more voids in the panel, such as one or more bores.

The arm may use magnets, snaps, hooks-and-loops, temporary adhesive or any other conventional fastener that causes the arm to be mounted to the wrist watch, watch band, bracelet or any other limb-encircling structure. The arm may furthermore include at least one strip of flexible material that fastens at one end to the structure, such as the arm or panel, extends around the watch band, and then fastens to the arm or panel. A watch band's incorporation of the invention may include replacing the conventional wristwatch band with a new band that includes the mounting feature or features that accommodate attachment of the structure to the band.

The band to which the structure attaches may be completely conventional, in which case the arm may have a clamping structure that permits the arm to attach to the band. In such an embodiment a portion of the arm forms a hook, on a side opposite the band from the panel, into which the watch band is inserted. A moveable hook is formed on the side of the band closer to the panel and opposite the first hook. The watch band is clamped between the two hooks, thereby maintaining the position of the panel on the band. In a preferred embodiment, the second hook is biased toward the first hook, thereby permitting attachment of the arm, and its attached panel, at any point around the watch band that the width of the band permits, with the opposed hooks applying an inwardly-directed bias to clamp the watch band therebetween. Thus, the user can mount the arm and panel, with the attached electronic device, just above or below the face of the watch, at the inside or outside of the wrist, adjacent the clasp on the interior of the wrist, or at any position between.

The clamp may alternatively have two flat jaws that extend from the panel to form the arm. These jaws clamp against the front and back wide faces of the watch band in the manner of a so-called “alligator clamp”. Such a clamp allows the jaws to engage the larger surface areas of the front and back faces of the watch band, the latter of which may seat against the wearer's skin, in order to more securely hold the panel to the wrist watch band. Of course, many other clamping or attaching mechanisms are contemplated for attaching the mounting panel to the arm.

### BRIEF DESCRIPTION OF THE SEVERAL VIEWS OF THE DRAWINGS

FIG. 1 is a view in perspective illustrating an embodiment of the present invention.

FIG. 2 is a view in perspective illustrating the embodiment of FIG. 1 with a computer mounted thereto.

FIG. 3 is a view in perspective illustrating a strip that may be attached to the embodiment of FIG. 1.

FIG. 4 is a view in perspective illustrating the embodiment of FIG. 1 with the strip of FIG. 3 mounted in an operable position.

FIG. 5 is a view in perspective illustrating the apparatus of FIG. 4 from a different perspective.

FIG. 6 is a view in perspective illustrating the apparatus of FIG. 4 from a different perspective than FIG. 4 or 5.

FIG. 7 is a view in perspective illustrating an alternative embodiment of the present invention.

FIG. 8 is a view in perspective illustrating another alternative embodiment of the present invention.

FIG. 9 is a view in perspective illustrating another alternative embodiment of the present invention.

FIG. 10 is a view in perspective illustrating the embodiment of FIG. 4 in an operable configuration on a conventional watch band.

FIG. 11 is a view in perspective illustrating the embodiment of FIG. 7 in an operable configuration on a conventional watch band.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

Provisional patent application Ser. No. 62/055,767, which is the above claimed priority application, is incorporated herein by reference.

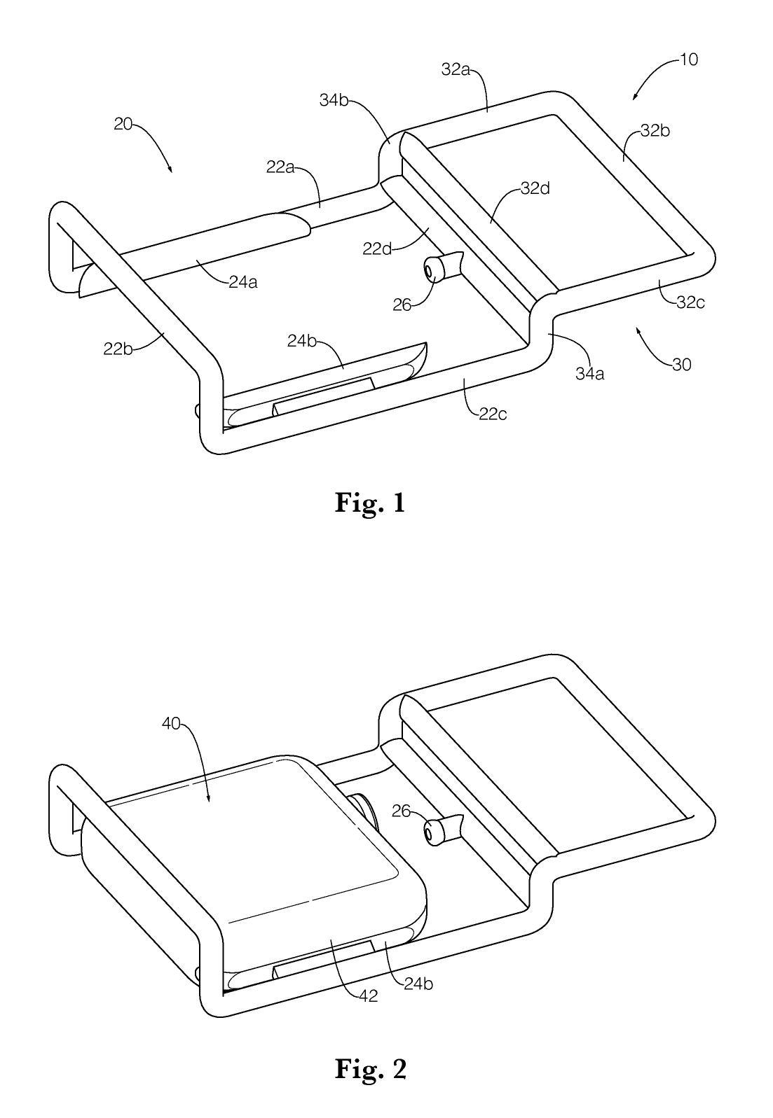

In an embodiment of the invention shown in FIGS. 1-6, the structure 8 is made up of a frame 10 that includes a panel 20 and an arm 30 mounted to the panel 20. In the embodiment of FIG. 1, the panel is made up of the members 22a, 22b, 22c and 22d, which form a frame that is rigid and sufficiently strong to accomplish the purposes described herein. The bars 24a and 24b extend from rigid mounting to the members 22a and 22c toward the opening in the panel 20, and, as shown in FIG. 2, provides the fastening means to mount the housing 40.

The housing 40 is shown in FIG. 2 with two opposing cavities 42 (opposite cavity not visible in FIG. 2, but has substantially identical shape and size as cavity 42) of corresponding shape to the bars 24a and 24b, and into which the bars fit. In one embodiment, the cavities are the same cavities as are found in an APPLE brand smart watch, particularly those that are used to receive the smart watch band. The housing 40 is shown as one type of housing, but the person of ordinary skill will understand that many types of electronic components can be substituted for the housing 40, including without limitation music playing devices, smartphones, personal digital assistants, and any other small computer that has a display that is desirably viewed by a human wearer. The electronic devices that may be used in association with the invention include, but are not limited to, smart phones, smart watches, personal digital assistants, geo-positioning satellite (GPS) devices, personal music devices (e.g., IPOS brand and IPOD TOUCH brand), and any electronic device that has a viewable face.

The arm 30 is made up of the members 32a, 32b, 32c and 32d, and the members 34a and 34b. The members 34a and 34b extend between the members 22a and 22c and the members 32a and 32c, respectively. The arm 30 thus extends rigidly from the panel 20, and permits the housing 40 to be mounted adjacent a watch band, bracelet or any other wrist-encircling (or other limb-encircling) article. A pin 26 extends from the member 22d to form part of the fastening means for the frame 10 as explained below.

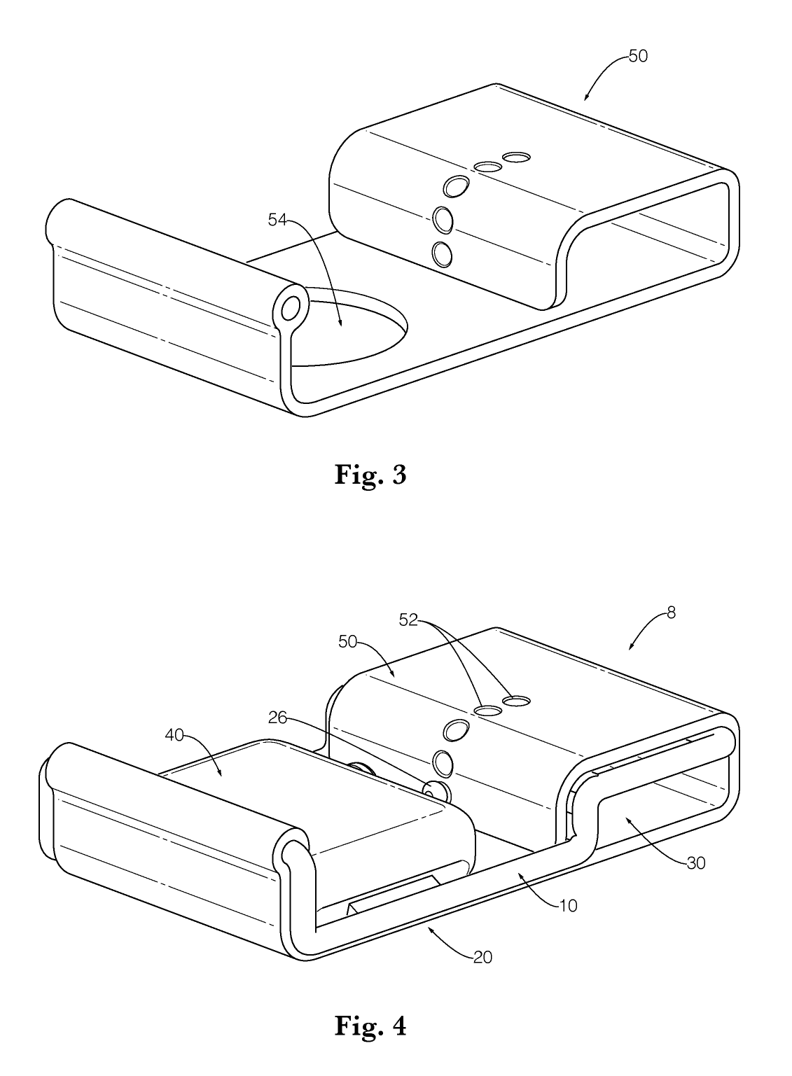

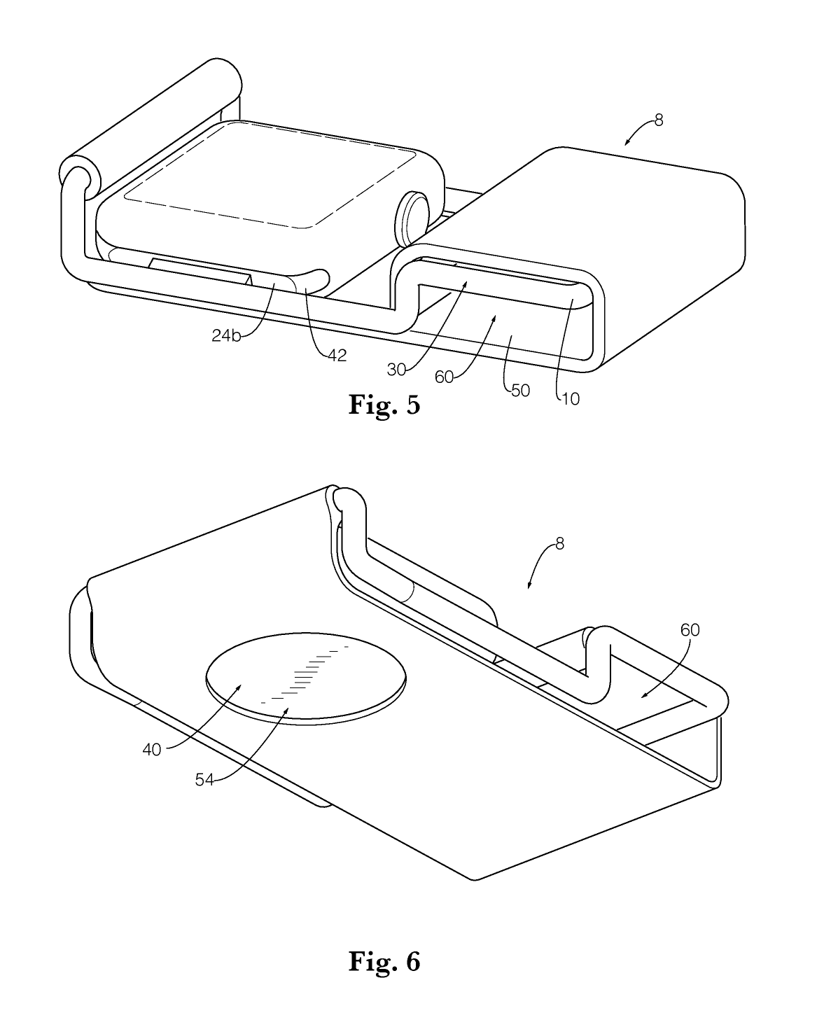

A flexible strip 50 (FIG. 3) may be mounted to the frame 10, as shown in FIG. 4 with the strip 50 encircling the member 22b. The strip may be silicone, leather, fabric, or any other suitable flexible material. The strip 50 extends beneath (in the orientation of FIG. 4) the housing 40 and around the watch band (not visible in FIG. 4), over the arm 30 and onto the pin 26 as shown. The pin 26 extends through a selected one of the openings 52 in the strip 50 to fix the end of the strip 50 to the frame 10, thereby encircling the watch band (not visible in FIG. 4) as shown in the illustrations.

The strip 50 has a large opening 54 (FIG. 3) formed in a predetermined location to permit access to the housing 40 by any physical object upon which the strip 50 and frame 10 rest. The physical object may be a person's arm or other limb, and the access to the housing may be for the purpose of a sensor (not visible) on the exterior of the housing 40 contacting the skin of the wearer for conventional use. The opening 54 is shown in FIG. 6 with the housing 40 visible through the opening 54.

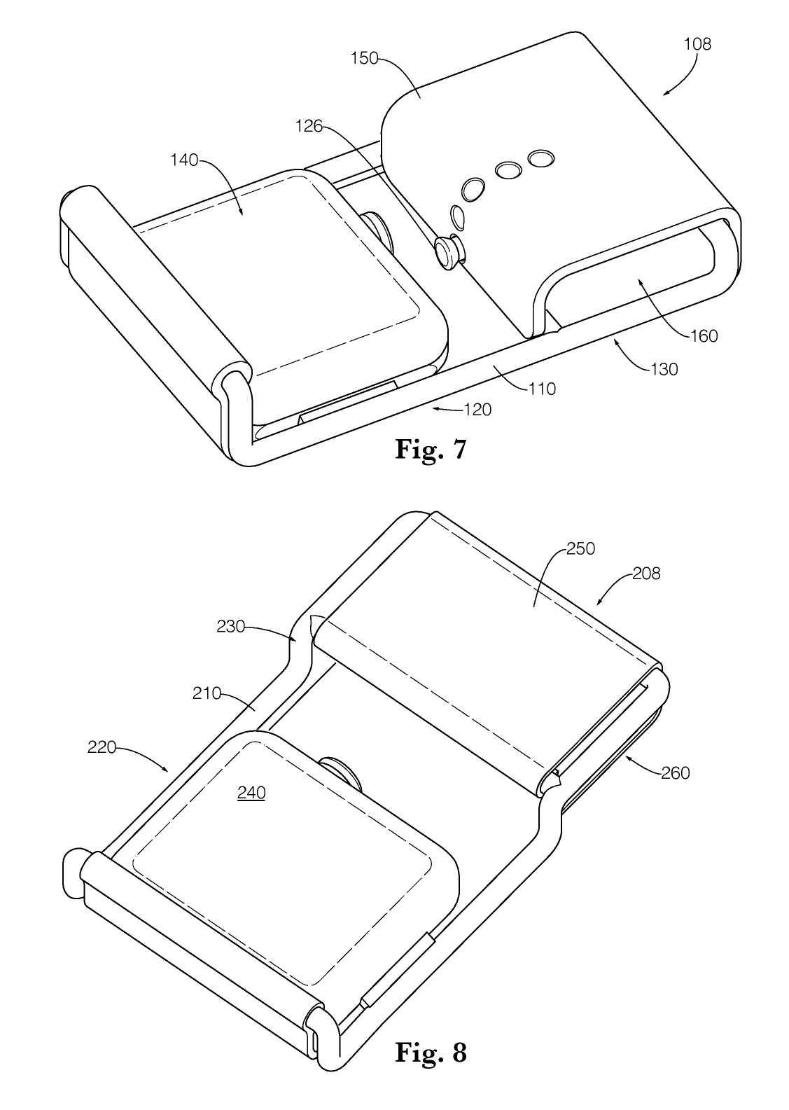

As shown in more detail in FIG. 10, the watch band 100 is disposed in the passage 60 that is formed between the arm 30 and the strip 50 (FIG. 5). Because of the adjustable manner in which the strip 50 mounts to the frame 10 (see FIG. 4), and particularly the pin 26, the passage 60 is substantially the same size as the object that is disposed therein. Thus, a firm attachment is formed between the strip 50, the contacting members of the frame 10 and the band 100. This attachment provides a friction grip, and because the wearer may have his or her arm resting against the entire plane of the surface 56, there is additional support tending to maintain the structure 8 on the band 100. This is similarly the case with the alternative embodiments and the passages 160 and 260 of the structures 108 and 208 in FIGS. 7 and 8, respectively.

When the structure 8 is mounted to a watch band 100 as shown in FIG. 10, the opening 54 permits an arm or other limb or body part on which the band 100 is encircling to contact the housing 40 through the opening 54. The structure and band 100 may be mounted on a leg or any other body part of a human or an animal.

Alternative embodiments to that shown in FIGS. 1-6 and described above are shown in FIGS. 7-9. The alternative embodiments are examples of many alternatives that will become apparent to the person having ordinary skill in the art from the description herein. The alternative embodiments have many similar components to those of the FIGS. 1-6 embodiment, as will be understood by the person of ordinary skill, and components shared by both are not described in detail below.

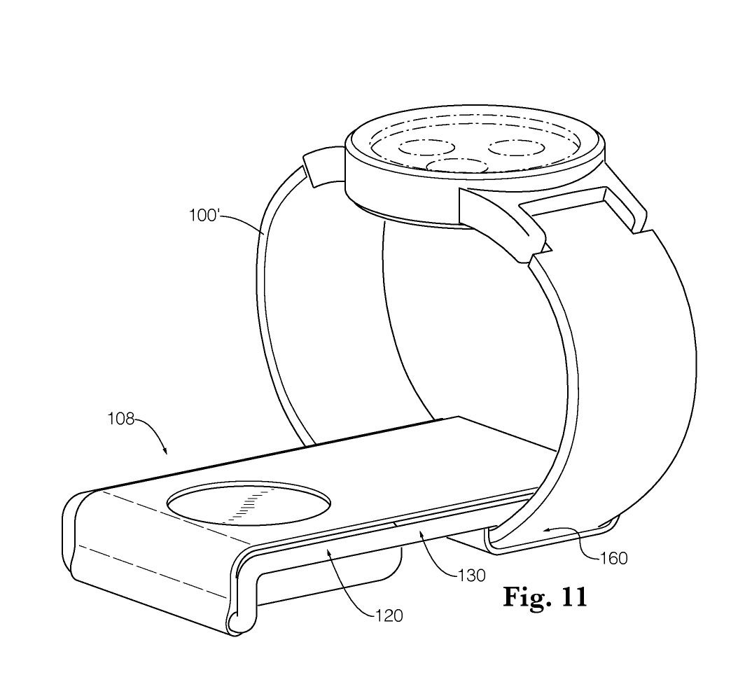

The alternative embodiment of FIG. 7 includes a frame 110 having a panel 120 and an arm 130 extending rigidly therefrom. The panel 120 and the arm 130 are in substantially the same plane, which differs from the panel 20 and arm 30 of the frame 10 FIG. 1. A strip 150 extends from an end of the panel 120, beneath the housing 140 (in the orientation of FIG. 7), and around the end of the arm 130 to the pin 126. This forms a passage 160 in which the watch band or equivalent structure may be disposed during attachment as shown in FIG. 11. The structure 108 has an advantage that the arm 130 may extend between the user's arm and/or wrist and the watch band 100′, thereby clamping the arm 130 and further enhancing the attachment of the structure 108 to the watch band 100′.

The alternative embodiment of FIG. 8 includes a frame 210 having a panel 220 and an arm 230 extending rigidly therefrom. The panel 220 and the arm 230 are in substantially different planes, which is similar to the configuration of the frame 10 of FIG. 1. A strip 250 extends from an end of the panel 220, beneath the housing 240 (in the orientation of FIG. 8), and around the end of the arm 230. This forms a passage 260 in which the watch band or equivalent structure may be disposed during attachment.

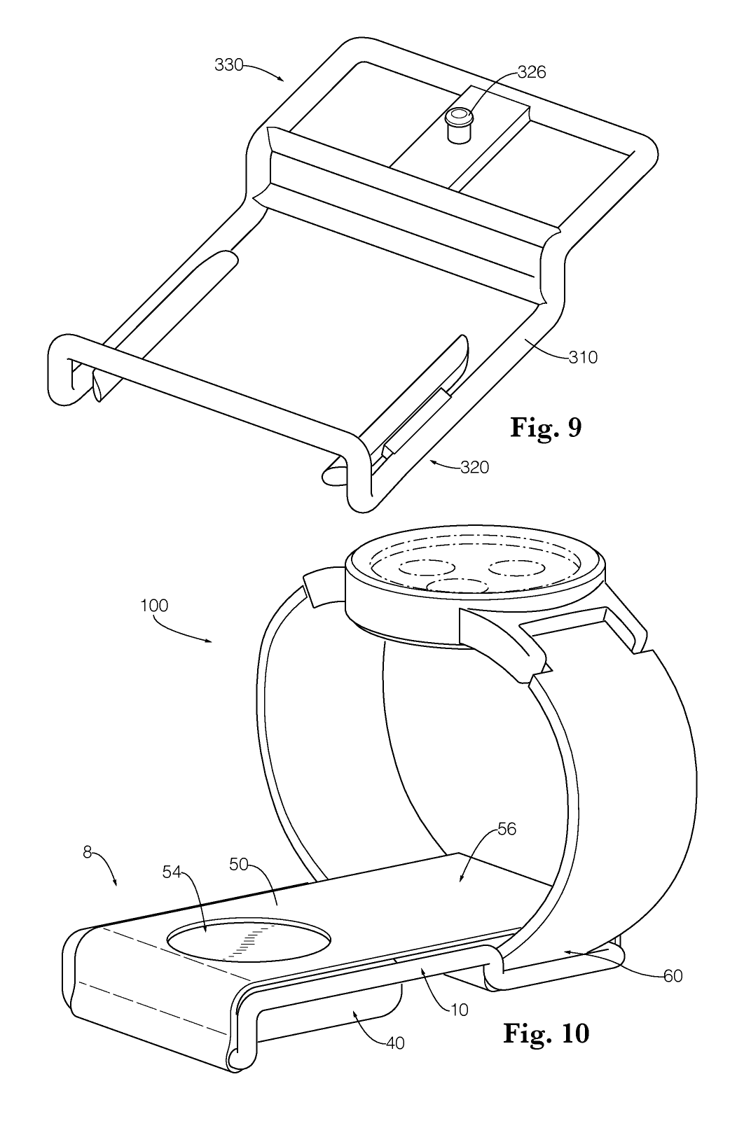

The alternative embodiment of FIG. 9 includes a frame 310 having a panel 320 and an arm 330 extending rigidly therefrom. The panel 320 and the arm 330 are in substantially different planes, which is similar to the configuration of the frame 10 of FIG. 1. The frame 310 has a pin 326 extending therefrom in order for a strip (not visible in FIG. 9, but similar to the strip 250 of FIG. 8) to extend from an end of the panel 320, beneath the frame 310 (in the orientation of FIG. 9), and around the end of the arm 330. This forms a passage below the arm 330 in which the watch band or equivalent structure may be disposed during attachment, and the pin 326 permits adjustable mounting of the strip on the FIG. 9 embodiment where the FIG. 8 embodiment has no such adjustability.

A power pack may be mounted to the structure 8 or any of the alternatives described herein, in order to provide power to the computer within the housing 40 while it in use. The power pack may contain a battery, capacitor or other electrical energy storage means, and it may also or alternatively include charging means, such as a photovoltaic cell, motion-charging devices, or any other charging apparatus. In one embodiment, the power pack may be mounted within the frame 10, such as in the space between the housing 40 and the pin 26 (FIG. 2) or in a space parallel to the housing 40 (see FIG. 4). Alternatively, the power pack may be mounted within the members that form the frame 10. The power pack may provide power to the computer within the housing 40 by a conventional wired or wireless connection. Similarly, the charging means may provide power to the power pack by a conventional wired or wireless connection.

The panel is also contemplated to house a battery, capacitor or other energy-retaining or energy-producing apparatus, such as a solar panel or a vibration-driven generator, in order that the electronic device mounted thereon can be powered or charged by this feature. In this embodiment, the electronic device may be charged by inductive or any other type of “wireless” charging, or a wire or port may be formed on the panel in order to connect the electronic device thereto for charging.

Although the mounting panel is shown mounted to one side of the watch band, the panel can be mounted to the opposite side thereof, because the mounting apparatus is preferably not direction-specific. It will become apparent from the description and drawings that the invention is not limited to one embodiment. Instead, there will be many structures that embody the invention.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. An apparatus for attaching a computer adjacent to a limb-encircling structure, the apparatus comprising:
(a) a substantially planar panel having at least one panel fastener to which the computer is mounted; and
(b) an arm extending rigidly from the panel having at least one fastener for attaching to the limb-encircling structure.

2. The apparatus in accordance with claim 1, wherein said at least one panel fastener comprises a flexible strip that extends from the panel to the arm and extends around the limb-encircling structure.

3. The apparatus in accordance with claim 2, wherein the flexible strip has an opening for aligning with the computer and the limb so that the computer can contact the limb when in an operable position.

4. The apparatus in accordance with claim 3, further comprising a power pack mounted to the panel and electrically connected to the computer to provide electrical power to the computer.

5. The apparatus in accordance with claim 1, wherein the arm further comprises at least two elongated rods that removably fasten to the limb-encircling structure.

6. The apparatus in accordance with claim 1, wherein the arm further comprises at least two elongated rods that extend from the limb-encircling structure and removably fasten to the panel.

7. An apparatus for attaching a computer to a band that is configured to encircle a human wrist, the apparatus comprising:
(a) a substantially planar panel;
(b) at least one fastener mounted to the panel and configured to removably fasten to the computer;
(c) an arm extending rigidly from the panel for attaching to the band; and
(d) at least one fastener mounted to the arm and configured to removably fasten to the band for disposing the computer adjacent the band.

8. The apparatus in accordance with claim 7, wherein said at least one fastener mounted to the arm further comprises a flexible strip that extends from the panel to the arm and extends around the band.

9. The apparatus in accordance with claim 8, further comprising a pin to which the strip is mounted by inserting the pin through an aperture in the strip.

10. The apparatus in accordance with claim 8, further comprising an opening in the strip that is configured to align with the computer housing and the wrist in an operable configuration.

11. The apparatus in accordance with claim 8, wherein the fastener mounted to the panel includes at least two opposing bars configured to extend into grooves in a housing containing the computer.

12. The apparatus in accordance with claim 7, further comprising a power pack mounted to the panel and electrically connected to the computer to provide electrical power to the computer.

13. A combination of a band configured to encircle a human wrist and an apparatus for disposing a computer adjacent the band, the combination comprising:
(a) a substantially planar panel;
(b) at least one fastener mounted to the panel and removably fastened to the computer;
(c) an arm extending rigidly from the panel; and
(d) at least one fastener mounted to the arm and removably fastened to the band.

14. The apparatus in accordance with claim 13, wherein said at least one fastener mounted to the arm further comprises a flexible strip that extends from the panel to the arm and extends around the band.

15. The apparatus in accordance with claim 14, further comprising a pin to which the strip is mounted by inserting the pin through an aperture in the strip.

16. The apparatus in accordance with claim 14, further comprising an opening in the strip that is configured to align with a housing containing the computer and the wrist when in an operable configuration.

17. The apparatus in accordance with claim 13, wherein the fastener mounted to the panel includes at least two opposing bars extending into grooves in a housing containing the computer.

18. The apparatus in accordance with claim 13, further comprising a power pack mounted to the panel and electrically connected to the computer to provide electrical power to the computer.
